(19) United States
(12) Patent Application Publication
(10) Pub. No.: US 2006/0051648 A1
(43) Pub. Date: Mar. 9, 2006

(54) Solid polymer electrolyte membrane, method for producing the same, and fuel cell including the solid poymer electrolyte membrane

(76) Inventors: Fusaki Fujibayashi, Yokohama (JP); Toshimitsu Tachibana, Osaka (JP); Souji Nishiyama, Osaka (JP); Youzou Nagai, Osaka (JP)

Correspondence Address: MCGUIREWOODS, LLP, 1750 TYSONS BLVD, SUITE 1800, MCLEAN, VA, 22102, US

(21) Appl. No.: 11/218,546

(22) Filed: Sep. 6, 2005

(30) Foreign Application Priority Data
Sep. 6, 2004 (JP) 2004-258169
Mar. 16, 2005 (KR) 10-2005-0021839

(51) Int. Cl. H01M 8/10; H01M 10/40; C08J 5/22

(52) U.S. Cl. 429/33; 429/309; 429/314; 429/317; 521/27

(57) ABSTRACT

A solid polymer electrolyte membrane is used to stably generate electricity under non-humidified conditions or conditions with a relative humidity of 50% or less at an operating temperature of 100° C. to 300° C. for a long period of time. A method of producing the same and a fuel cell including the solid polymer electrolyte membrane are also provided. The solid polymer electrolyte membrane comprises a component A comprising at least a basic polymer such as polybenzimidazoles, polybenzoxazoles, and polybenzthiazoles, a component B comprising at least a basic polymer such as a porous polyolefin resin grafted by a vinyl monomer, a porous fluorinated polyolefin resin grafted by a vinyl monomer, and a porous polyimide resin grafted by a vinyl monomer, and a component C comprising at least an inorganic acid such as a sulfuric acid, a phosphoric acid, and a condensed phosphoric acid.

### CROSS-REFERENCE TO RELATED APPLICATIONS

This application claims priority to and the benefit of Japanese Patent Application No. 2004-258169, filed on Sep. 6, 2004, in the Japanese Patent Office, and Korean Patent Application No. 10-2005-0021839, filed on Mar. 16, 2005, in the Korean Intellectual Property Office, the disclosures of which are incorporated herein in their entirety by reference.

### BACKGROUND OF THE INVENTION

1. Field of the Invention

The present invention relates to a solid polymer electrolyte membrane for a fuel cell, a method of producing the same, and a fuel cell that includes the solid polymer electrolyte membrane. In particular, the present invention relates to a solid polymer electrolyte membrane that is used to stably generate electricity under non-humidified conditions or conditions with a relative humidity of 50% or less at an operating temperature of 100° C. to 300° C. for a long period of time. In addition, the invention provides a method of producing the same, and a fuel cell that includes the solid polymer electrolyte membrane.

2. Description of the Background

Ion conductors, through which ions move when electricity is applied, are widely used in electrochemical devices such as batteries, electrochemical sensors, and the like.

For example, proton conductors, which have stable proton conductivity under non-humidified conditions or conditions with a relative humidity of 50% or less at an operating temperature of 100° C. to 300° C. even when used for a prolonged period of time may be used in fuel cells. Such proton conductors have good power generating efficiency, system efficiency, and long-term durability of composing elements. Therefore, a significant amount of research into solid polymer fuel cells has been conducted. However, a solid polymer fuel cell that includes a perfluorocarbonsulfonic acid electrolyte membrane cannot generate sufficient electricity under non-humidified conditions or conditions with a relative humidity of 50% or less at an operating temperature of 100° C. to 300° C.

In addition, a membrane that includes a proton conducting agent (such as that disclosed in Japanese Laid-Open Patent No. 2001-035509), a silica dispersing membrane (such as that disclosed in Japanese Laid-Open Patent No. Hei 06-111827), an inorganic-organic composite membrane (such as that disclosed in Japanese Laid-Open Patent No. 2000-090946), a grafted membrane doped with phosphoric acid (such as that disclosed in Japanese Laid-Open Patent No. 2001-213987), and an ionic liquid composite membrane (such as that disclosed in Japanese Laid-Open Patent Nos. 2001-167629 and 2003-123791) have been developed. However, all of these are not suitable for stably generating sufficient electricity under non-humidified conditions or conditions with a relative humidity of 50% or less at an operating temperature of 100° C. to 300° C.

In addition, phosphoric acid fuel cells, solid oxide fuel cells, and molten salt fuel cells operate at temperatures much higher than 300° C. so that long-term durability of composing elements are undesirable and the manufacturing costs are high. In order to solve these problems, a solid polymer fuel cell including a polymer electrolyte membrane composed of polybenzimidazole doped with a strong acid such as a phosphoric acid, was developed. (See U.S. Pat. No. 5,525,436). The solid polymer fuel cell may generate sufficient electricity at temperatures as high as 200° C. In this case, however, long-term stability for electricity generation was not guaranteed.

Thus, conventional techniques for developing these fuel cells are far behind the desired level.

### SUMMARY OF THE INVENTION

The present invention provides a solid polymer electrolyte membrane that is used to stably generate electricity under non-humidified conditions or conditions with a relative humidity of 50% or less at an operating temperature of about 100° C. to about 300° C. for a long period of time.

The present invention also provides a method of producing the solid polymer electrolyte membrane.

The present invention also provides a fuel cell that includes the solid polymer electrolyte membrane.

Additional features of the invention will be set forth in the description which follows, and in part will be apparent from the description, or may be learned by practice of the invention.

The present invention discloses a solid polymer electrolyte membrane comprising a component A comprising at least a basic polymer such as polybenzimidazoles, polybenzoxazoles, and polybenzthiazoles, a component B comprising at least a base polymer such as a porous polyolefin resin grafted by a vinyl monomer, a porous fluorinated polyolefin resin grafted by a vinyl monomer, and a porous polyimide resin grafted by a vinyl monomer, and a component C comprising at least an inorganic acid such as a sulfuric acid, a phosphoric acid, and a condensed phosphoric acid.

The present invention also discloses a method for producing a solid polymer electrolyte membrane comprising impregnating a component A that is dissolved in an organic solvent into a component B, vaporizing the organic solvent to form a polymer film, and doping the polymer film with a component C. In this method, component A comprises at least a basic polymer such as polybenzimidazoles, polybenzoxazoles, and polybenzthiazoles, component B comprises at least a base polymer such as a porous polyolefin resin grafted by a vinyl monomer, a porous fluorinated polyolefin resin grafted by a vinyl monomer, and a porous polyimide resin grafted by a vinyl monomer, and component C comprises at least an inorganic acid such as a sulfuric acid, a phosphoric acid, and a condensed phosphoric acid.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a graph of a cell potential with respect to initial operation for a current density for the fuel cells of Example 1 and Comparative Example 1.

FIG. 2 is a graph of an open circuit voltage and cell potential of when a current density is 0.3 A/cm² with respect to operating time for the fuel cells of Example 1 and Comparative Example 1.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

A solid polymer electrolyte membrane according to an exemplary embodiment of the present invention comprises a component A including a basic polymer, a component B including a base polymer, and a component C including an inorganic acid.

The base polymer of component B is a polymer that is grafted by a vinyl monomer, has great affinity with the component A, has pores, and can be impregnated with component A and component C. Thus, the solid polymer electrolyte membrane of the present invention includes the base polymer of component B impregnated with component A and component C.

Component A may include a basic polymer such as polybenzimidazoles, polybenzoxazoles, and polybenzthiazoles, for example.

Polybenzimidazoles may include polymers that are represented by chemical structures (a), (b), and (c) and derivatives of these. In particular, the derivatives may be methylated polybenzimidazoles that are substituted with a methyl group. Polybenzoxazoles may include polymers that are represented by chemical structures (d), (e), and (f) and derivatives of these. Polybenzthiazoles may include polymers that are represented by chemical structures (g), (h), and (i) and derivatives of these. The polybenzimidazoles, polybenzoxazoles, and polybenzthiazoles have excellent heat-resisting properties and can accept a lot of inorganic acids that make up component C, which are very desirable characteristics for a solid polymer electrolyte membrane. 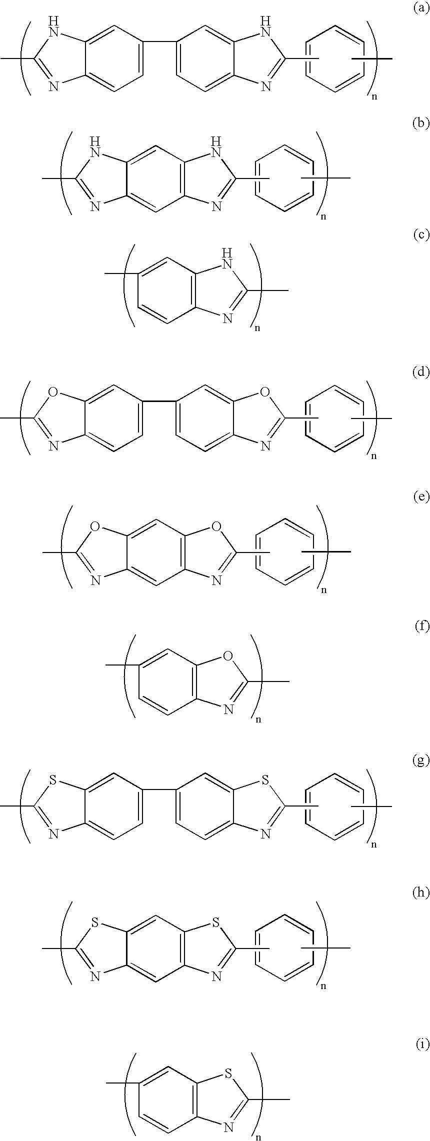
In chemical structures (a) to (i), n ranges from about 10 to about 100,000. When n≧10, component A exhibits sufficient mechanical strength, and when n≦100,000, component A may dissolve easily in an organic solvent and is suitable for the solid polymer electrolyte membrane.

These basic polymers may be manufactured using well-known techniques. For example, methods of forming polybenzimidazoles are disclosed in U.S. Pat. Nos. 3,313,783, 3,509,108, and 3,555,389.

Component B may include at least a base polymer including, but not limited to a porous polyolefin resin grafted by a vinyl monomer, a porous fluorinated polyolefin resin grafted by a vinyl monomer, and a porous polyimide resin grafted by a vinyl monomer.

The component B may also include at least a resin such as a polyolefin resin, a fluorinated polyolefin resin, and a polyimide resin, for example, each of which are grafted by at least a vinyl monomer.

The polyolefin resin may include a homopolymer or a copolymer such as a low-density polyethylene, a high-density polyethylene, a super high molecular weight polyethylene, a polypropylene, poly-4-methylpentene, and the like. The porous fluorinated polyolefin resin may include a homopolymer or a copolymer such as a perfluoroolefin, such as tetrafluoroethylene hexafluoropropylene, chlorotrifluorene ethylene, perfluoro (alkylvinylether), and the like. The polyimide resin may include a repeated unit formed by imidazation between an acid residue and an amine residue as a backbone. The polyimide may further include other copolymer components or a blend component. The polyimide resin may have an aromatic group at its backbone, or it may be a polymer of a tetracarbonic acid and an aromatic diamine in terms of heat resistance, low linear expansion coefficient, low humidity adsorption.

The polyolefin resin, the fluorinated polyolefin resin, and the polyimide resin may be formed in a sheet or a film, for example, with a thickness of about 5 μm to about 200 μm. When the resin is less than 5 μm thick, swelling is less suppressed, and when it is thicker than 200 μm, membrane resistance increases and the manufacturing costs increase.

In addition, the polyolefin resin, the fluorinated polyolefin resin, and the polyimide resin may be porous. The porosity may be about 15% to about 85% and the average pore diameter may be about 0.01 μm to about 30 μm, but these ranges are not limited thereto.

A method for preparing a porous resin may vary depending on the type of resin. For example, the method may include a wet process, melt drawing, sintering, and the like. A polyolefin resin can be obtained by methods disclosed in Japanese Laid-Open Patent No. Sho 62-121737 and Japanese Laid-Open Patent No. Hei 3-205433, for example. The fluorinated resin such as a porous polytetrafluoroethylene membrane may be obtained by a drawing method disclosed in Japanese Laid-Open Patent Nos. Sho 58-25332, Sho 42-13560, Sho 58-119834, Hei 9-302121, Hei 5-202217, and Hei 10-30031, for example. It may also be obtained by a method using a foaming agent such as that disclosed in Japanese Laid-Open Patent No. Sho 42-4974. The polyimide resin may be formed using methods disclosed in Japanese Laid-Open Patent Nos. Hei 7-232044, and Hei 6-116166, and Japanese Laid-Open Patent No. 2001-89593, but are not limited thereto.

In addition, the polyolefin resin, the fluorinated polyolefin resin, and the polyimide resin which are used to form the base polymer of component B may be grafted by a vinyl monomer.

The vinyl monomer used for the grafting may include a polar functional group that has an affinity with component A. The polar functional group may include, but is not limited to a carboxyl group, an amino group, a quaternary amino group, a sulfonic group, a phosphone group, a phosphine group, and a phenolic hydroxy group. A vinyl monomer containing these polar functional groups has good interactions with the basic polymer. In addition, although compounds such as styrene do not include a polar functional group, such vinyl monomers may also be used in the present embodiment because a polar functional group can be introduced to the styrene by sulfonification after graft polymerization, for example.

Vinyl monomers that include a carboxyl group may include, but are not limited to an acrylic acid, an α-ethylacrylic acid, a β-ethylacrylic acid, an α-pentylacrylic acid, a β-nonylacrylic acid, a methacrylic acid, a crotonic acid, an itaconic acid, a maleic acid, or the like.

Vinyl monomers that include an amino group may include, but are not limited to N-vinylphenylamine, arylamine, triarylamine, vinylpyridine, methylvinylpyridine, ethylvinylpyridine, vinylpyrrolidone, vinylcarbazole, vinylimidazole, aminostyrene, alkylaminostyrene, dialkylaminostyrene, trialkylaminostyrene, dimethylaminoethylmethacrylate, diethylaminomethacrylate, dicyclohexylaminoethylmethacrylate, di-n-propylaminoethylmethacrylate, t-butylaminoethylmethacrylate, diethylaminoethylacrylate, or the like.

Vinyl monomers that include a quaternary amino group may be a hydrochloric acid salt, a sulfuric acid salt, an acetic acid salt, or a phosphoric acid salt of the vinyl monomer that include the quaternary amino group, for example.

Vinyl monomers that include a sulfonic group may be a styrenesulfonic acid, a vinylsulfonic acid, an arylsulfonic acid, a sulfopropylacrylate, sulfopropylmethacrylate, a 3-chloro-4-vinylbenzenesulfonic acid, a 2-acrylamide-2-methyl-propanesulfonic acid, a 2-acryloyloxybenzenesulfonic acid, a 2-acryloyloxynaphthalene-2-sulfonic acid, or a 2-methacryloyloxynaphthalene-2-sulfonic acid, for example.

Vinyl monomers that include a phosphone group may include an arylphosphonic acid, an acidphosphoxyethylmethacrylate, 3-chloro-2-acidphosphoxypropylmethacrylate, a 1-methylvinylphosphonic acid, a 1-phenylvinylphosphonic acid, a 2-phenylvinylphosphonic acid, a 2-methyl-2-phenylvinylphosphonic acid, a 2-(3-chlorophenyl)vinylphosphonic acid, or a 2 -diphenylvinylphosphonic acid, for example.

Vinyl monomers that include a phosphine group may include, but are not limited to arylphosphinic acid. Vinyl monomers that include a phenolic hydroxy group may be an o-oxystyrene, o-vinylanisole, or the like.

The graft polymerization may be performed using radiation graft polymerization or laser exposure graft polymerization. Radiation graft polymerization may be performed using a pre-radiation method or a simultaneous radiation method. The pre-radiation method may include forming a radical by radiating onto a polyolefin resin, for example, and then contacting a vinyl monomer to the resulting polyolefin resin. Simultaneous radiation may be performed by radiating a polyolefin resin or the like and then contacting a vinyl monomer. In the graft polymerization, the amount of radiation, such as electron ray, α ray, β ray, γ ray, and X ray may depend on the type of the vinyl monomer, the temperature of the co-polymerization, or the like. The amount of radiation may be about 1 to about 200 kGy.

In this case, the polyolefin resin or the like may be immersed in or doped with the vinyl monomer or a solution containing the same such that the polyolefin resin or the like contacts the vinyl monomer or the solution containing the same. At this time, a polymerization inhibitor such as a hydroquinone, hydrazine, and the like, may be added to prevent polymerization between the vinyl monomers. The polyolefin resin or the like may contact the vinyl monomer at a temperature of about −20° C. to the boiling point of the monomer for 10 seconds to 24 hours. However, the contact time and temperature may vary depending on the type of the monomer and the amount of the radiation.

The graft rate of the vinyl monomer onto the polyolefin resin or the like may be about 5% to about 200%, but may vary depending on the type of the monomer, or the like. The graft rate may be obtained by measuring the difference between the weight of a film before and after the graft polymerization, dividing the difference by the weight of the film before the graft polymerization, and multiplying by 100. When the graft rate is less than about 5%, the graft polymerization produces no effects. When the graft rate is more than about 200%, the strength of the polyolefin resin decreases, or pores are blocked when the polyolefin resin is porous.

The component C may include at least an inorganic acid including, but not limited to a sulfuric acid, a phosphoric acid, and a condensed phosphoric acid. The component C is miscible with the basic polymer of component A, and induces an expression of proton conductivity in the solid polymer electrolyte membrane.

The blending ratio of each component of the solid polymer electrolyte membrane will now be described.

The concentration of component A may be about 30 wt % to about 99.5 wt % and preferably about 50 wt % to about 99 wt % based on the total weight of component A and component B. The concentration of component B may be about 0.5 wt % to about 70 wt %, and preferably about 1 wt % to about 50 wt %. When the concentration of component A may be about 30 wt % to about 99.5 wt %, the addition of the component C may guarantee stable long-term electricity generating performance.

The concentration of component C may be about 20 mol % to about 2000 mol %, preferably about 50 mol % to about 1500 mol % based on the repeated unit of the basic polymer of component A. When the concentration of component C is 20 mol % or more, stable electricity generating performance may be obtained. When the concentration of component C is less than 2000 mol %, no elution of component C and stable long-term electricity generation is possible.

A method for producing the solid polymer electrolyte membrane may include impregnating component A dissolved in an organic solvent to component B vaporizing the organic solvent to form a polymer film, and doping the polymer film with component C.

The polymer film comprising component A and component B may be formed by conventional methods disclosed in Japanese Laid-Open Patent No. Hei 8-259710, for example. The organic solvent that dissolves component A is selected considering the solubility of component A and the impregnating properties of the component A into the component B. The organic solvent may include, but is not limited to dimethylacetamide, dimethylformamide, dimethylsulfide, and N-methyl-2-pyrrolidone. The polymer film may be doped with component C by immersing the polymer film in a strong acid for a predetermined period of time.

A solid polymer fuel cell according to the present invention is a fuel cell that comprises the solid polymer electrolyte membrane as described above. A unit cell of the solid polymer fuel cell may be formed by interposing a solid polymer electrolyte membrane between an oxygen electrode and a fuel electrode, forming a separator that has an oxidant channel at the side of the oxygen electrode, and forming a separator that has fuel channel at the side of the fuel electrode.

Such a solid polymer fuel cell may stably generate electricity under non-humidified conditions or conditions with a relative humidity of 50% or less at an operating temperature of about 100° C. to about 300° C. for a long period of time. In addition, it is suitable for use in cars or houses for generating electricity.

Hereinafter, the present invention will be described in detail with reference to following Examples and Comparative Example 1.

In Example 1, Example 2, Example 3, and Example 4, and Comparative Example 1, fuel cells including solid polymer electrolyte membranes are fabricated and the amount of the component C doped are measured. Then, the electricity generating performances of the fuel cells were evaluated. In these examples, the solid polymer electrolyte membranes were interposed between a fuel cell electrode (Electrochem Co.) to form membrane electrode assemblies, which operated by using hydrogen and air under non-humidified conditions at 130° C.

### Example 1

A porous polytetrafluoroethylene sheet that is 10 cm wide, 10 cm long, 85 μm thick, has an average pore diameter of 3 μm, and a porosity of 82% were radiated with an electron ray of 30 kGy. The electron ray was generated by operating an electron ray accelerating apparatus at an accelerating voltage of 2,000,000 V and a 10 mA beam of current in an ambient condition, thus generating a radical. The porous sheet with a radical was grafted by immersing it in a solution of 4-vinylpyridine at 60° C. for 4 hours and then in ethanol for 1 hour to remove a homopolymer of the 4-vinylpyridine. As a result, a grafted porous polytetrafluoroethylene containing vinylpyridine with a graft rate of 27% was obtained.

Separately, 10 wt % of poly-2,2′-(m-phenylene)-5,5′-bibenzimidazole was dissolved in dimethylacetamide. The grafted porous sheet was immersed in the resulting solution so that the porous sheet was impregnated with the poly-2,2′-(m-phenylene)-5,5′-bibenzimidazol. Then, the dimethylacetamide was removed by vaporization to form a polymer film, in which 85 wt % of poly-2,2′-(m-phenylene)-5,5′-bibenzimidazole and 15 wt % of the grafted porous polytetrafluoroethylene was obtained. The weight fractions were discerned by measuring weights of the polymer film before and after impregnation.

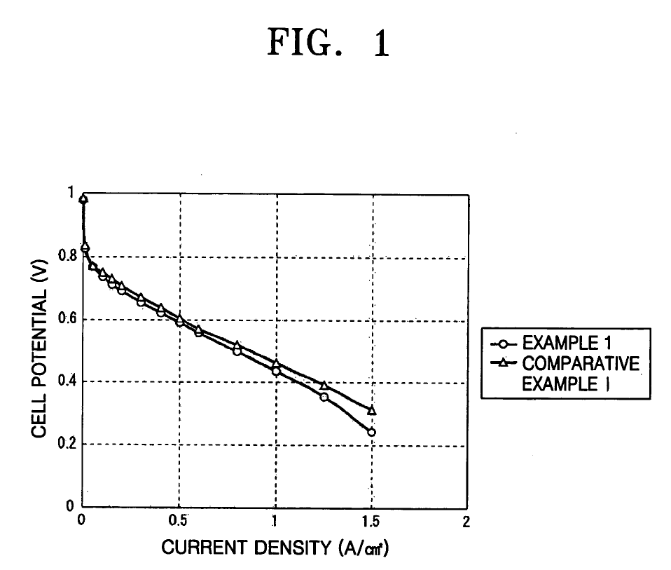

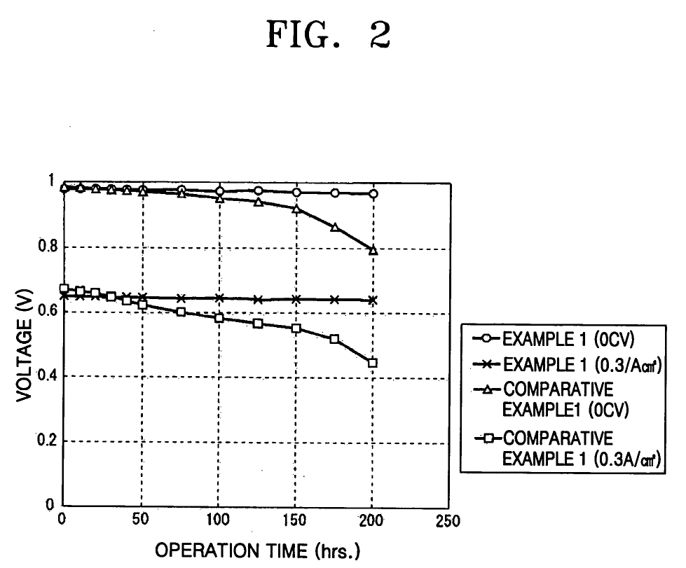

The polymer film was directly immersed in an 85% ortho-phosphoric acid solution at room temperature for 2 hours to dope it with the phosphoric acid. The resulting polymer film formed a solid polymer electrolyte membrane. The amount of the inorganic acid, which was measured from the weight difference, was 750 mol % per repeated unit of poly-2,2′-(m-phenylene)-5,5′-bibenzimidazole. In addition, before the weight measurement, the solid polymer electrolyte membrane was dried in vacuum at 120° C. for 2 hours to remove if an adsorbed moisture. The solid polymer electrolyte membrane thus obtained was used to form a fuel cell, for which electricity generating performance was measured. FIG. 1 illustrates current density-cell potential characteristics for initial operation. FIG. 2 is a graph of an open circuit voltage and cell potential when the current density is 0.3 A/cm².

### Example 2

A 70 μm porous polytetrafluoroethylene porous sheet with an average pore diameter of 0.1 μm and a porosity of 68% were prepared, and vinylpyridine was grafted in the same way as in Example 1. As a result, a grafted porous polytetrafluoroethylene containing vinylpyridine with a graft rate of 10% was obtained.

The polymer film was prepared in the same manner as in Example 1 using the above grafted porous polytetrafluoroethylene. A polymer film with 75 wt % of poly-2,2′-(m-phenylene)-5,5′-bibenzimidazole and 25 wt % of the grafted bibenzimidazole was obtained.

The polymer film was doped with a phosphoric acid in the same manner as in Example 1, and the resulting polymer film formed a solid polymer electrolyte membrane. The concentration of the inorganic acid was 540 mol %. The electricity generating performance was measured for a fuel cell using the solid polymer electrolyte membrane in the same manner as in Example 1. The open circuit voltage and cell potential when the current density was 0.3 A/cm² of the fuel cell were measured at initial operation and 200 hours after the initial operation. The results are shown in Table 1.

### Example 3

The porous sheet of Example 1 was radiated with a 30 kGy electron ray, which was generated by operating an electron ray accelerating apparatus at an accelerating voltage of 2,000,000 V and a beam current of 10 mA at ambient conditions to generate a radical. The porous sheet with a radical was grafted by immersing it in a solution of styrene dissolved in toluene at 60° C. for 4 hours and then in toluene for 1 hour to remove a homopolymer of the toluene. Then, the resulting graft polymer was immersed in a 0.1 M chlorosulfonic acid in a tetrachloroethane solution at 60° C. for 12 hours to produce a grafted porous polytetrafluoroethylene group including a sulfonic acid with a graft rate of 10%.

The polymer film was prepared in the same manner as in Example 1 using the above grafted porous polytetrafluoroethylene. A polymer film with 87 wt % of poly-2,2′-(m-phenylene)-5,5′-bibenzimidazole and 13 wt % of the grafted bibenzimidazole was obtained.

The polymer film was doped with a phosphoric acid, and the resulting polymer film formed a solid polymer electrolyte membrane. The concentration of the inorganic acid was 810 mol %. The electricity generating performance was measured for a fuel cell using the solid polymer electrolyte membrane in the same manner as in Example 1. The open circuit voltage and cell potential when the current density was 0.3 A/cm² of the fuel cell were measured at initial operation and 200 hours after the initial operation. The results are shown in Table 1.

### Example 4

The porous sheet of Example 2 was grafted in the same way as in Example 3 by grafting a sulfonic acid group, to obtain a porous polytetrafluoroethylene with a 10% graft ratio.

The polymer film was prepared in the same way as in Example 1 using the above grafted porous polytetrafluoroethylene. A polymer film with 72 wt % of poly-2,2′-(m-phenylene)-5,5′-bibenzimidazole and 28 wt % of the grafted bibenzimidazole was obtained.

The polymer film was doped with a phosphoric acid in the same manner as in Example 1, and the resulting polymer film formed a solid polymer electrolyte membrane. The concentration of the inorganic acid was 510 mol %. The electricity generating performance was measured for a fuel cell using the solid polymer electrolyte membrane in the same manner as in Example 1. The open circuit voltage and cell potential when the current density was 0.3 A/cm² of the fuel cell were measured at initial operation and 200 hours after the initial operation. The results are shown in Table 1.

### Example 5

A solid polymer electrolyte membrane was formed in the same manner as in Example 1 except that the polymer film was immersed in a heated 450 mol % phosphoric acid solution at 60° C. to dope it. The solid polymer electrolyte membrane was used to form a fuel cell, for which the electricity generating performance was measured using the same method as in Example 1. The open circuit voltage and cell potential when the current density was 0.3 A/cm² of the fuel cell were measured at initial operation and 200 hours after the initial operation. The results are shown in Table 1.

### Comparative Example 1

Poly-2,2′-(m-phenylene)-5,5′-bibenzimidazole was doped with 600 mol % of an phosphoric acid, thus forming a solid polymer electrolyte membrane. The electrolyte membrane was used to form a fuel cell for which the electricity generating performance was measured using the same method as in Example 1. FIG. 1 illustrates current density and cell potential characteristics for initial operation. FIG. 2 is a graph of an open circuit voltage and cell potential with respect to time when the current density was 0.3 A/cm².

TABLE 1

| | | | | | | | Comparative |
|---|---|---|---|---|---|---|---|
| | | Example 1 | Example 2 | Example 3 | Example 4 | Example 5 | Example 1 |
| Initial | Voltage(V) (open | 0.978 | 0.980 | 0.981 | 0.986 | 0.971 | 0.985 |
| operation | circuit voltage) | | | | | | |
| | Cell Potential | 0.654 | 0.655 | 0.658 | 0.660 | 0.661 | 0.671 |
| | (V) (0.3 A/cm²) | | | | | | |
| 200 hours | Voltage(V) (open | 0.968 | 0.962 | 0.966 | 0.969 | 0.961 | 0.796 |
| after initial | circuit voltage) | | | | | | |
| operation | Cell Potential | 0.641 | 0.647 | 0.645 | 0.648 | 0.632 | 0.447 |
| | (V) (0.3 A/cm²) | | | | | | |

In Table 1, open circuit voltages of the fuel cells of Examples 1 to 5 and Comparative Example 1 were measured at initial operation and 200 hours after the initial operation. In addition, cell potentials of the fuel cells of Examples 1 to 5 and Comparative Example 1 were measured at a current density of 0.3 A/cm³ at initial operation, and 200 hours after the initial operation.

As shown in Table 1, the fuel cells exhibited similar open circuit voltages and cell potential at a current density of 0.3 A/cm² at initial operation. However, 200 hours after the initial operation, it was confirmed that the fuel cell of Comparative Example 1 deteriorated compared to the fuel cells of Examples 1 to 5.

FIG. 1 is a graph of voltage with respect to current density of the fuel cells of Example 1 and Comparative Example 1 at initial operation. As shown in FIG. 1, at initial operation, as the current density increases, the voltage of the fuel cells of Example 1 and Comparative Example 1 were similar to each other.

FIG. 2 is a graph of the open circuit voltage and cell potential with respect to time of the fuel cells of Example 1 and Comparative Example 1 at a current density of 0.3 A/cm². As illustrated in FIG. 2, the open circuit voltage and cell potential of the fuel cell of Comparative Example 1 at a current density of 0.3 A/cm² decreases as time elapses. On the other hand, the open circuit voltage and the cell potential at a current density of 0.3 A/cm² of the fuel cell of Example 1 do not decrease.

As described above, the solid polymer electrolyte membrane including component B of Examples 1 to 5 have stronger durability than the electrolyte membrane of Comparative Example 1.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A solid polymer electrolyte membrane, comprising:
a component A comprising at least a basic polymer selected from the group consisting of polybenzimidazoles, polybenzoxazoles, and polybenzthiazoles;
a component B comprising at least a basic polymer selected from the group consisting of a porous polyolefin resin grafted by a vinyl monomer, a porous fluorinated polyolefin resin grafted by a vinyl monomer, and a porous polyimide resin grafted by a vinyl monomer; and
a component C comprising at least an inorganic acid selected from the group consisting of a sulfuric acid, a phosphoric acid, and a condensed phosphoric acid.

2. The solid polymer electrolyte membrane of claim 1,
wherein the component B is a porous polytetrafluoroethylene grafted by a vinyl monomer.

3. The solid polymer electrolyte membrane of claim 1,
wherein the basic polymer of component B is formed in an about 5 μm to about 200 μm thick sheet or film.

4. The solid polymer electrolyte membrane of claim 1,
wherein the concentration of component A is about 30 wt % to about 99.5 wt % based on the total weight of component A and component B.

5. The solid polymer electrolyte membrane of claim 1,
wherein the concentration of component C is about 20 mol % to about 2000 mol % per the repeated unit of the basic polymer of component A.

6. The solid polymer electrolyte membrane of claim 1,
wherein the vinyl monomer comprises at least a compound selected from the group consisting of an acrylic acid, an α-ethylacrylic acid, a β-ethylacrylic acid, an α-pentylacrylic acid, a β-nonylacrylic acid, a methacrylic acid, a crotonic acid, an itaconic acid, a maleic acid, N-vinylphenylamine, arylamine, triarylamine, vinylpyridine, methylvinylpyridine, ethylvinylpyridine, vinylpyrrolidone, vinylcarbazole, vinylimidazole, aminostyrene, alkylaminostyrene, dialkylaminostyrene, trialkylaminostyrene, dimethylaminoethylmethacrylate, diethylaminomethacrylate, dicyclohexylaminoethylmethacrylate, di-n-propylaminoethylmethacrylate, t-butylaminoethylmethacrylate, diethylaminoethylacrylate, a hydrochloric acid salt with a quaternary amino group, a sulfuric acid salt with a quaternary amino group, an acetic acid salt with a quaternary amino group, and a phosphoric acid salt with a quaternary amino group, a styrenesulfonic acid, a vinylsulfonic acid, an arylsulfonic acid, a sulfopropylacrylate, sulfopropylmethacrylate, a 3-chloro-4-vinylbenzenesulfonic acid, a 2-acrylamid-2-methyl-propanesulfonic acid, a 2-acryloyloxybenzenesulfonic acid, a 2-acryloyloxynaphthalene-2-sulfonic acid, a 2-methacryloyloxynaphthalene-2-sulfonic acid, an arylphosphonic acid, an acidphophoxyethylmethacrylate, 3-chloro-2-acidphophoxypropylmethacrylate, a 1-methylvinylphosphonic acid, a 1-phenylvinylphosphonic acid, a 2-phenylvinylphosphonic acid, a 2-methyl-2-phenylvinylphosphonic acid, a 2-(3-chlorophenyl) vinylphosphonic acid, a 2-diphenylvinylphophonic acid, an arylphosphinic acid, an o-oxystyrene, and an o-vinylanisole.

7. The solid polymer electrolyte membrane of claim 1,
wherein a graft rate of the vinyl monomer is about 5% to about 200%.

8. A method for producing a solid polymer electrolyte membrane, comprising:
impregnating a component A dissolved in an organic solvent into a component B;
vaporizing the organic solvent to form a polymer film; and
doping the polymer film with a component C,
wherein component A comprises at least a basic polymer selected from the group consisting of polybenzimidazoles, polybenzoxazoles, and polybenzthiazoles,
wherein component B comprises at least a basic polymer selected from the group consisting of a porous polyolefin resin grafted by a vinyl monomer, a porous fluorinated polyolefin resin grafted by a vinyl monomer, and a porous polyimide resin grafted by a vinyl monomer, and
wherein component C comprises at least an inorganic acid selected from the group consisting of a sulfuric acid, a phosphoric acid, and a condensed phosphoric acid.

9. The method of claim 8,
wherein the organic solvent comprises at least a compound selected from the group consisting of dimethylacetamide, dimethylformamide, dimethylsulfide, and N-methyl-2-pyrrolidone.

10. A fuel cell, comprising:
a unit cell,
wherein the unit cell comprises:
an oxygen electrode;
a fuel electrode;
the solid polymer electrolyte membrane of claim 1 interposed between the oxygen electrode and the fuel electrode;
a separator that comprises an oxidant channel and is formed at the oxygen electrode; and
a separator that comprises a fuel channel and is formed at the fuel electrode.
